(19) United States
(12) Patent Application Publication
(10) Pub. No.: US 2003/0129304 A1
(43) Pub. Date: Jul. 10, 2003

(54) Mono-, di- or tribasic propellants for gun ammunition and method of making the same

(76) Inventors: Ulrike Jeck-Prosch, Unterschleissheim (DE); Peter Lange, Obing (DE); Ursula Seffner-Lehner, Waldkraiburg (DE)

Correspondence Address: VENABLE, BAETJER, HOWARD AND CIVILETTI, LLP, P.O. BOX 34385, WASHINGTON, DC, 20043-9998, US

(21) Appl. No.: 09/512,669

(22) Filed: Feb. 24, 2000

(30) Foreign Application Priority Data
Feb. 24, 1999 (DE) 199 07 809.2

(51) Int. Cl. B05D 7/00

(52) U.S. Cl. 427/212

(57) ABSTRACT

The invention relates to method of producing mono-, di- or tribasic propellants for gun ammunition, in which mono-, di- or tribasic propellants are surface-treated with the aid of desensitizing substances. The surface treatment flattens the maximum pressure curve of the propellant in the operating temperature range of the weapon. The desensitizing substances comprise inert or energetic polymers and energetic, monomer softeners or mixtures of the two components.

### CROSS REFERENCE TO RELATED APPLICATION

This application claims priority from German Application 199 07 809.2 filed Feb. 24, 1999, which is incorporated herein in its entirety by reference.

### BACKGROUND OF THE INVENTION

The invention relates to propellants for gun ammunition, particularly mono-, di- or tribasic propellants, having surface treatments of desensitizing substances and method of making the same.

In conventional mono-, di- or tribasic propellants for gun ammunition, such as powders comprising nitrocellulose, nitric acid esters (e.g., nitroglycerine, diethyl glycol dinitrate, triethylene glycol dinitrate, butane triol trinitrate, and metriol trinitrate), alkyl nitrato ethyl nitramines, nitroguanidine, hexogen (RDX [cyclonite, hexogen, T4, cyclo-1,3,5,-trimethylene-2,4,6,-trinitramine, hexahydro-1,3,5-trinitro-S-triazine]), octogen (HMX [cyclo-1,3,5,7-tetramethylene 2,4,6,8-tetranitramine]), 3-nitro-1,2,4-triazol-5-one (NTO), hexanitrohexaazaisowurtzitane (CL-20) or mixtures of such powders, or powders mixed with additives (such as stabilizers), the maximum pressure of the combustion curve occurring during firing, and the muzzle velocity of the corresponding projectile, are extensively dependent on the ambient temperature of the weapon. Because the weapon is designed for attaining the maximum pressure occurring within the temperature range for which the weapon is specified (e.g., −40° C. to 60° C.), and this pressure is not normally maximized in the range of the temperature (21° C.) at which the weapon is primarily used, the theoretically possible performance capability of the weapon is normally not met (i.e., in firing at the temperature of primary use).

There have been numerous attempts to develop propellants in which the temperature dependence of the maximum pressure is relatively flat, so that the weapon approaches its optimum performance capability in the broadest-possible temperature range.

For example, German Offenlegungsschrift (application published without examination) 33 46 287 discloses a propellant in which an approximately constant combustion behavior is attained in the range around the temperature of primary use by means of a mixture of homogeneous and inhomogeneous powder components. One of the disadvantages of this known propellant, however, is that the homogeneous and inhomogeneous powder components must be matched precisely to one another. Otherwise, the firing behavior of the propellant varies from firing to firing.

It is known from German Patent No. 25 20 882 that the temperature gradient, which is typically positive in conventional propellants (i.e., an increase in the maximum pressure with an increasing ambient temperature), can be flattened in the range of the temperature of primary use by providing the powder granules of the propellant with inside channels having different cross sections. A disadvantage of this propellant is that it is relatively costly to produce.

J. Köhler and R. Meyer's book “Explosivstoffe” (“Explosives”), published by VCH Verlagsgesellschaft mbH, Weinheim, 7^{th} Revised and Expanded Edition, pp. 233 et seq., proposes to flatten the maximum pressure of the combustion curve of conventional propellants by additionally subjecting these powders to a surface treatment employing combustion-retarding (desensitizing) substances. Non-energetic, monomolecular substances such as phthalates (dibutyl phthalate), ureas (Centralit) or camphor are used as desensitizers.

An observed disadvantage of the above-mentioned desensitizers is that they reduce the energy content of the propellant, and effect a substantial loss in the performance as compared to the untreated powder. These substances also tend in part (especially phthalates, for example) to migrate into the propellant, and have a detrimental impact on its ballistic function.

### SUMMARY OF THE INVENTION

It is an object of the present invention to provide a propellant, and a method of producing the propellant, in which the maximum-pressure curve can easily be flattened in the temperature range for which the weapon is specified.

This object and others are met by a composition of matter comprising propellants for gun ammunition surface treated with at least one of inert or energetic polymers and energetic, monomer softeners.

The concept underlying the invention is to perform a surface treatment on conventional mono-, di- or tribasic powders using special desensitizers, namely only those that have little or no tendency to migrate.

The desensitizers of the invention include inert or energetic polymers or large-volume monomers that practically do not migrate at all, and energetic, monomolecular substances, or mixtures of the components, that reduce the energy loss to a level that yields no perceptible decrease in performance capability during the firing of the weapon.

The surface treatment of the propellants can be accomplished by any known method of surface treatment. For example, the surface treatment may be sprayed on, as a solution or an emulsion, in a treatment drum, particularly a rotating treatment drum, or an impregnation method may be performed, in which the propellant is incubated in the treatment solution or emulsion for a specified period of time.

The following substances, used alone or as mixtures, have proven particularly advantageous for surface treatment:

non-energetic polyesters, polyethers, polyurethanes, polyureas, polybutadienes, polyamides, cellulose esters (such as cellulose acetate, cellulose acetobutyrate, cellulose propionate);

energetic polymers (e.g., poly-3-nitratomethyl-3-methyl oxetane (poly-NMMO), polyglycidylnitrate(poly-GLYN), and glycidylazide polymer (GAP));

alkyl nitrato ethyl nitramines (e.g., methyl nitrato ethyl nitramine (methyl-NENA), ethyl nitrato ethyl nitramine (methyl-NENA), and butyl nitrato ethyl nitramine (methyl-NENA));

dinitro diazaalkanes;

nitric acid esters (e.g., diethylene glycol dinitrate);

nitroglycerine, triethylene glycol dinitrate, butane triol trinitrate, and metriol trinitrate; and

bis(2,2-dinitropropyl) acetal (BDNPA), bis(2,2-dinitropropyl) formal (BDNPF).

### BRIEF DESCRIPTION OF THE DRAWINGS

FIGS. 1 and 2 show the dependence of the maximum pressure and the muzzle velocity on the ambient temperature of a first propellant, with and without the surface treatment according to the invention.

FIGS. 3 and 4 show the temperature dependencies of the maximum pressure and muzzle velocity, as illustrated in FIG. 1, for a second propellant.

FIGS. 5 and 6 show the temperature dependencies of the maximum pressure and muzzle velocity, as illustrated in FIG. 1, for a third propellant.

FIG. 7 is a plan view of a surface-treated powder granule.

FIG. 8 is a sectional view taken along line VIII-VIII of FIG. 7.

FIG. 9 is a sectional view, similar to FIG. 8, of a further embodiment.

### DETAILED DESCRIPTION OF THE PREFERRED EMBODIMENTS

### Example 1

The propellant powder for which the surface treatment of the invention is to be performed is a dibasic propellant powders L 5460 used for 120-mm kinetic energy ammunition and has the following composition:

| | |
|---|---|
| Nitrocellulose | 59.5% |
| Nitroglycerine | 14.9% |
| Diethylene glycol dinitrate | 24.8% |
| Akardite II (Methyl Diphenylurea) | 0.7% |
| Other | 0.1%. |

A 4% ethanolic solution of ethyl-NENA is sprayed onto the propellant powder L 5460 in four portions in a conventional treatment drum. The surface-treated powder is dried and subsequently subjected to different firing tests.

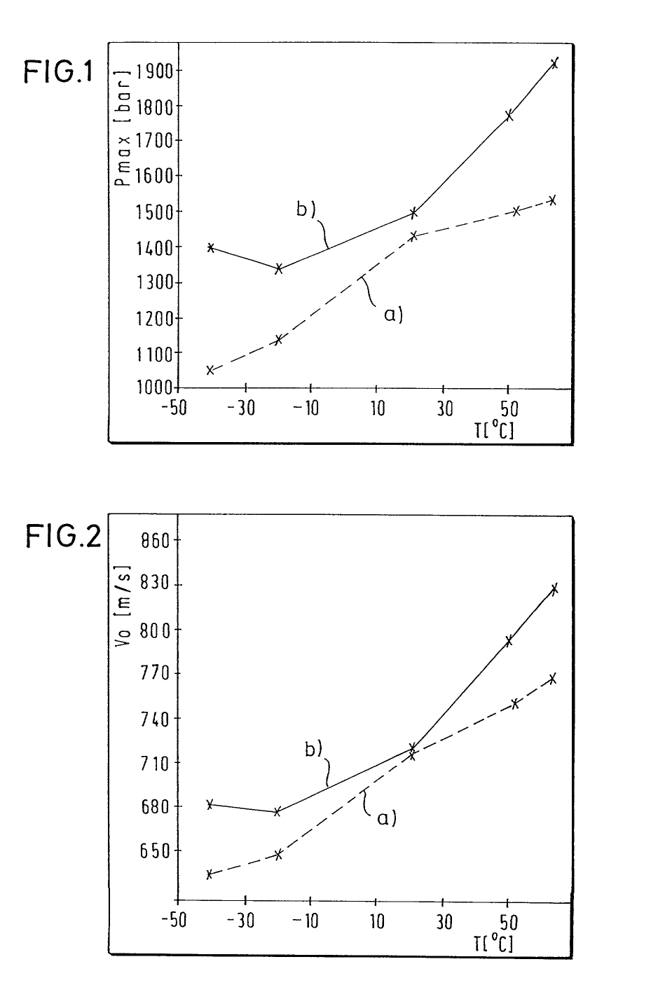

FIGS. 1 and 2 illustrate the result of the temperature firing using the surface treated powder in a 40-mm simulator (curve a) in comparison to untreated L 5460 (curve b). The maximum pressure (Pₘₐₓ) of the combustion curve and the muzzle velocity (vₒ) are shown as a function of the temperature.

The results indicate that the surface-treated L 5460 has a distinctly flattened temperature dependence of the maximum pressure and the muzzle velocity in the temperature range between 21° C. and 63° C. in comparison to the untreated powder.

### Example 2

The dibasic L 5460 described above is used again as the propellant powder for surface treatment according to the invention.

Palamoll 632, a polyester comprising adipic acid and propane-1,2-diol, is applied to the surface of L 5460 in an ethanolic emulsion (Palamoll: EtOH=1:3). The treatment with 1.5% of the polymer is effected in a rotating treatment drum at 45° C. The emulsion, divided into four portions, is successively added over a period of five hours; the solvent is simultaneously evaporated. Graphite is added multiple times during the treatment to prevent the granules from sticking.

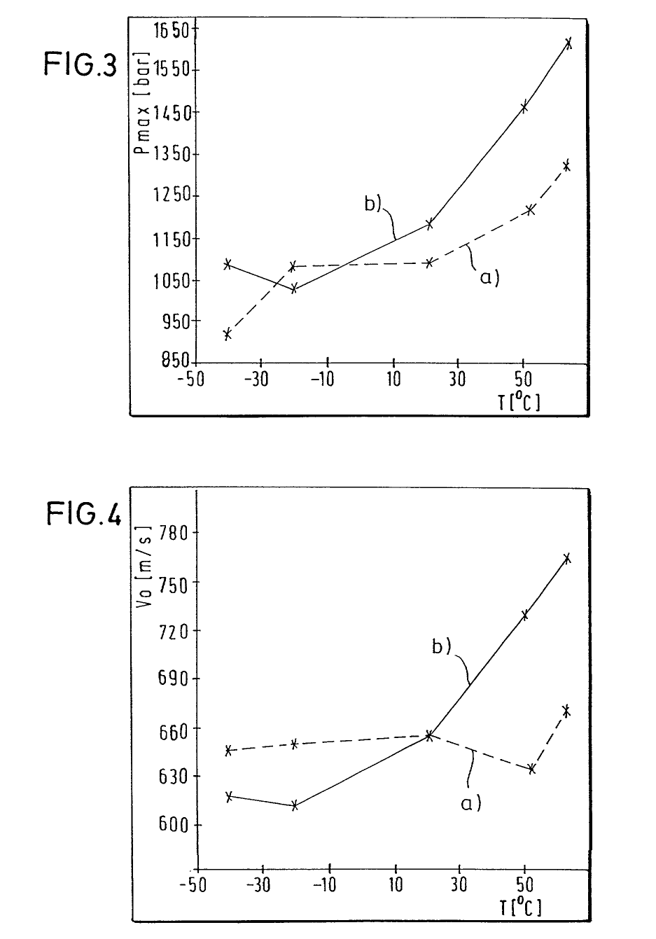

FIGS. 3 and 4 show the firing results of this powder in a 40-mm simulator from −40 to +63° C., in comparison to an untreated L 5460. The maximum pressure and the muzzle velocity are, again, shown as a function of the temperature.

In this case, a distinct flattening of the pressure and velocity curves once again can be seen between 21° C. and +63° C. (curve a) in comparison to the untreated propellant powder (curve b).

Table 1 lists the specific energy for the powders described in the previous two examples.

TABLE 1

| | | | Specific Energy |
|---|---|---|---|
| | Treatment | | [J/g] |
| L 5460 | | | 1165 |
| Example 1 | 4% | ethyl-NENA | 1165 |
| Example 2 | 1.5% | polyester | 1145 |

The values for the specific energy indicate that the methods of the invention effect little or no loss in the performance capability of the propellants.

### Example 3

A monobasic, 7-hole propellant powder C/M 0800 that was produced with nitrocellulose as the energy carrier and Centralite I as the stabilizer is incubated in an emulsion of nitroglycerine in water in a rotating drum at 30° C until the solution is clarified.

The powder is then subjected to a second treatment in an emulsion of Palamoll 632 in water.

In this way, 10% nitroglycerine and 2% Palamoll were applied.

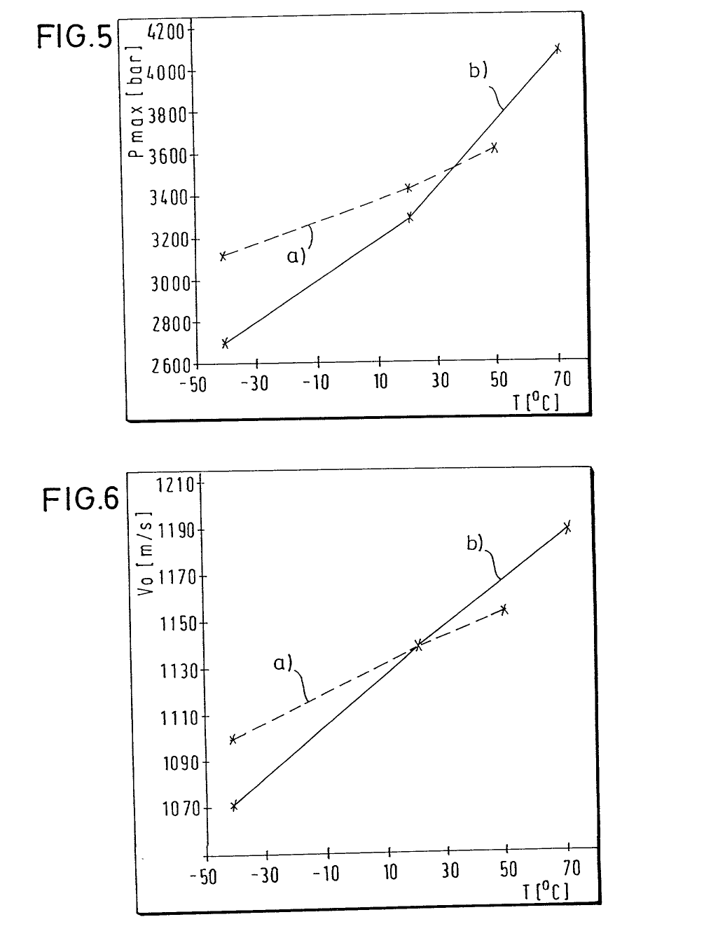

FIGS. 5 and 6 show the results of a weapon firing with this powder in a 35-mm training ammunition (curve a), in comparison to a monobasic propellant powder B 6320 (curve b) normally used.

While the conventional monobasic propellant B 6320 exhibits a significant increase in pressure and muzzle velocity between 21° C. and 70° C., in the treated C/M 0800, a reduction in the temperature gradient is indicated in the range between 21° C. and 52° C. Thus, a distinct improvement in performance capability in comparison to the conventional propellant powder can also be anticipated in the medium-caliber range with these treated powders.

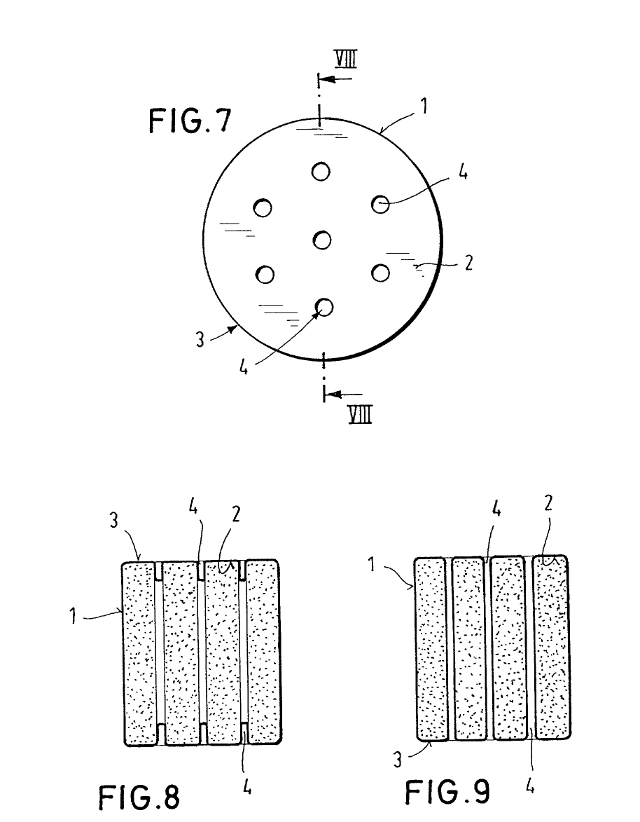

As microscopic examinations and tests involving combustion interruption in a ballistic bomb have shown, the desensitizer 1 deposits at the surface 2 of the respective powder granule represented by 3 in FIGS. 7, 8 and 9. The inside holes 4 of the propellant powder are also partially (FIG. 8) or completely (FIG. 9) covered by the desensitizer 1, or can even be completely sealed by the desensitizer. This coating 1 of the propellant granules 3 presumably results in the desired change in the combustion behavior of the propellant, and thus in the observed reduction of the temperature gradient.

The method can be used for known 1-, 7- and 19-hole propellants and those having cylindrical, hexagonal or rosette-shaped outer geometries.

The powder that is surface-treated according to the invention further exhibits a reduced sensitivity to special stresses, as can occur, for example, during enemy firing, in comparison to untreated propellants of the same composition.

It will be understood that the above description of the present invention is susceptible to various modifications, changes and adaptations, and the same are intended to be comprehended within the meaning and range of equivalents of the appended claims.

What is claimed is:

1. A composition of matter comprising a propellant for gun ammunition surface treated with at least one of an inert or energetic polymer and energetic, monomer softener.

2. The composition of claim 1, wherein the propellant is at least one of mono-, di- and tri-basic propellants for gun ammunition.

3. The composition of claim 2, wherein the propellant comprises at least one of nitrocellulose, a nitric acid ester, an alkyl nitrato ethyl nitramine, nitroguanidine, hexogen, octogen, 3-nitro-1,2,4-triazol-5-one, and hexanitrohexaazaisowurtzitane.

4. The composition of claim 3, wherein the nitric acid ester is at least one of nitroglycerine, diethylene glycol dinitrate, butane triol trinitrate, metriol trinitrate, and triethylene glycol dinitrate.

5. The composition of claim 1, wherein the polymer is at least one of polyester, polyether, polyurethane, polyurea, polybutadiene, polyamide, and cellulose ester.

6. The composition of claim 1, wherein the polymer comprises at least one of poly-3-nitratomethyl-3-methyl oxetane, polyglycidylnitrate, and glycidylazide polymer.

7. The composition of claim 1, wherein the energetic softener comprises at least one of alkyl nitrato ethyl nitramine, nitric acid ester, bis(2,2-dinitropropyl) acetal, bis(2,2-dinitropropyl) formal, and dinitrodiazaalkane.

8. The composition of claim 7, wherein the alkyl nitrato ethyl nitramine comprises at least one of methyl nitrato ethyl nitramine, ethyl nitrato ethyl nitramine, and butyl nitrato ethyl nitramine.

9. The composition of claim 7, wherein the nitric acid ester comprises at least one of nitroglycerine, diethyl glycol dinitrate, triethylene glycol dinitrate, butane triol trinitrate, and metriol trinitrate.

10. A method for producing a propellant powder for gun ammunition, comprising the step of surface-treating the propellant powder with an agent comprising at least one of inert or energetic polymer and energetic, monomer softener.

11. The method of claim 10, wherein the propellant is at least one of mono-, di- and tri-basic propellants for gun ammunition.

12. The method of claim 11, wherein the propellant comprises at least one of nitrocellulose, a nitric acid ester, an alkyl nitrato ethyl nitramine, nitroguanidine, hexogen, octogen, 3-nitro-1,2,4-triazol-5-one, and hexanitrohexaazaisowurtzitane.

13. The method of claim 12, wherein the nitric acid ester is at least one of nitroglycerine, diethylene glycol dinitrate, butane triol trinitrate, metriol trinitrate, and triethylene glycol dinitrate.

14. The method of claim 10, wherein the polymer is at least one of polyester, polyether, polyurethane, polyurea, polybutadiene, polyamide, and cellulose ester.

15. The method of claim 10, wherein the polymer comprises at least one of poly-3-nitratomethyl-3-methyl oxetane, polyglycidylnitrate, and glycidylazide polymer.

16. The method of claim 10, wherein the energetic softener comprises at least one of alkyl nitrato ethyl nitramine, nitric acid ester, bis(2,2-dinitropropyl) acetal, bis(2,2-dinitropropyl) formal, and dinitrodiazaalkane.

17. The method of claim 16, wherein the alkyl nitrato ethyl nitramine comprises at least one of methyl nitrato ethyl nitramine, ethyl nitrato ethyl nitramine, and butyl nitrato ethyl nitramine.

18. The method of claim 16, wherein the nitric acid ester comprises at least one of nitroglycerine, diethyl glycol dinitrate, triethylene glycol dinitrate, butane triol trinitrate, and metriol trinitrate.

19. The method of claim 10, wherein the surface-treating step comprises the step of applying the agent, as one of a solution and an emulsions; by one of spraying in a rotating drum and incubating in an impregnating solution.

20. The method of claim 10, wherein the polymer components and the energetic, monomer softener components are applied by one of application of a mixture of the two components and through a two-stage, consecutive treatment.
